(19) United States
(12) Patent Application Publication
(10) Pub. No.: US 2019/0069536 A1
(43) Pub. Date: Mar. 7, 2019

(54) POSITIONABLE AND CONVERTIBLE FOLDING DECOY

(71) Applicant: Flint Holdings, LLC, Hummelstown, PA (US)

(72) Inventors: Carroll J. Davis, Edgefield, SC (US); Jerry McPherson, Colstrip, MT (US)

(21) Appl. No.: 15/694,371

(22) Filed: Sep. 1, 2017

(51) Int. Cl. A01M 31/06

(52) U.S. Cl. CPC A01M 31/06

(57) ABSTRACT

An animal decoy device is presented. The animal decoy device includes a first pocket of fabric material includes a band disposed within the first pocket to bias the first pocket into an expanded shape. The device also includes a second pocket of a second fabric material a second band disposed within the second pocket to bias the second pocket into an expanded shape. The second pocket is configured to removably couple to the first pocket in at least a first position with respect to the first pocket and a second position with respect to the second pocket.

### FIELD OF THE INVENTION

The present invention relates to folding animal decoys that are easy to break-down for transportation and are easy to set-up and move in the field due to their light weight and portability.

### BACKGROUND

Animal decoys to attract animals may be used when hunting or nature watching. There are many different types of decoys, for example, full-bodied replicas of deer, elk, and other big game decoys are available on the market. Some full-bodied replica decoys include moveable parts, for example, such as a moveable head and/or tail. However, these full-bodied replicas tend to be constructed of various foams and/or plastics and can be bulky and difficult to transport into the field.

There are also two-dimensional expandable or folding decoys that show a photographic or realistic representation of an animal. These two-dimensional decoys are typically foldable and lightweight making them ideal for transporting into the field. However, two-dimensional decoys do not include moveable or positionable parts. Thus, there is an unfulfilled need for a two-dimensional decoy with moveable and positionable parts that retains its ease in transport and set-up/breakdown due to its light weight construction and foldability.

### SUMMARY

Embodiments of the invention include animal decoys that are lightweight and portable for a person to easily carry and use in the field. In accordance with one embodiment, the invention is an animal decoy comprising a body that includes a pocket of fabric material, a metal band disposed within the pocket, wherein the metal band is configured to bias the body into an expanded shape. The metal band is collapsible by twisting and folding the metal band on itself. Fasteners attached to the fabric material may be used to attach a second pocket of a second fabric material, with a metal band disposed within the second pocket. The second metal band is configured to bias the head into an expanded shape, the second metal band being collapsible by twisting and folding the second metal band on itself. A third fastener attached to the second fabric material is configured to removably couple to other fasteners to position the head in a first position or second position with respect to the body.

In another embodiment, an animal decoy includes a first portion including a pocket of fabric material and a band disposed within the pocket, wherein the band is configured to bias the first portion into an expanded shape. The band is collapsible by twisting and folding the band on itself. A second portion includes a second pocket of a second fabric material and a second band disposed within the second pocket. The second band is configured to bias the second portion into an expanded shape. The second portion is configured to removably couple to the first portion in at least a first and second position with respect to the first portion.

### BRIEF DESCRIPTION OF THE DRAWINGS

The detailed description is set forth with reference to the accompanying figures. The use of the same reference numbers in different figures indicates similar or identical items or features.

FIG. 1 illustrates a side view of an animal decoy, according to an embodiment of the invention.

FIG. 2 illustrates a side view of the animal decoy shown in FIG. 1 with the head and neck in a different position.

FIG. 3A illustrates a cross-section side view of the animal decoy shown in FIG. 1, according to an embodiment.

FIG. 3B illustrates a top view of the embodiment of FIG. 3A.

FIG. 4 illustrates a schematic of several steps used in performing a “twist-fold” to either collapse or expand the present animal decoy.

FIG. 5A illustrates a front view of a decoy attachment according to an embodiment.

FIG. 5B illustrates a side view of a decoy attachment piece according to an embodiment.

FIG. 6A illustrates a side view of a decoy with an attachment piece in place according to an embodiment.

FIG. 6B illustrates a side view of a decoy with an attachment piece removed according to an embodiment.

### DETAILED DESCRIPTION

While hunting or animal watching, it is important to conceal or mask human presence in the area. By strategically placing an animal decoy in an area, the decoy may attract or entice other animals to come into that area. Often these outdoor activities take place in rural areas or far from hubs of human activity, so it may be necessary for participants to travel, sometimes by foot, for great distances to find a place to install or position a decoy. This creates a need for a decoy that can be easily transported, even in rough terrain. This may be particularly true if participants want to move a decoy to different areas while out in the field.

The present invention is an animal decoy that may be easily compacted and secured for storage or transport, is relatively lightweight, and is easily deployed in the field. In various embodiments described herein, different types of animal decoys are described. In some embodiments, the decoy may be a deer decoy. For example, the deer decoy may have an exterior that shows a realistic representation of a deer. The realistic representation of the deer may be attained in a number of different ways. For example, the deer decoy may have a soft fabric exterior and the soft fabric exterior may be imprinted with a realistic representation of a deer.

While the invention is susceptible to various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

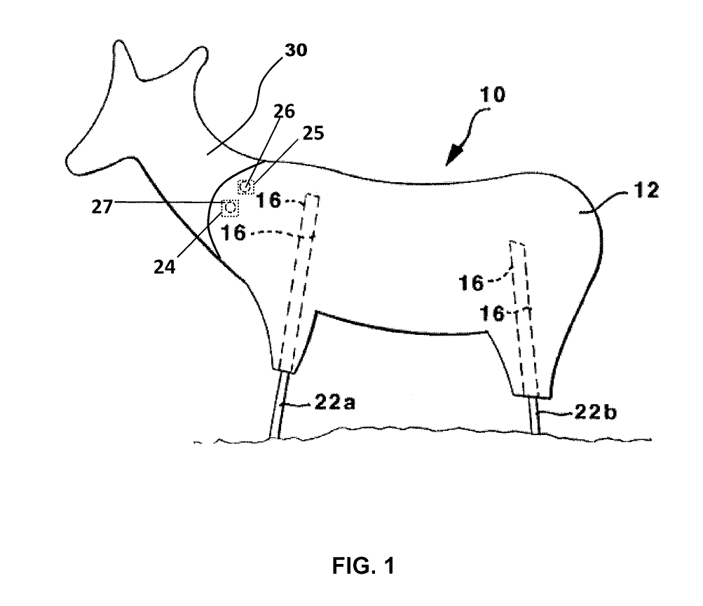

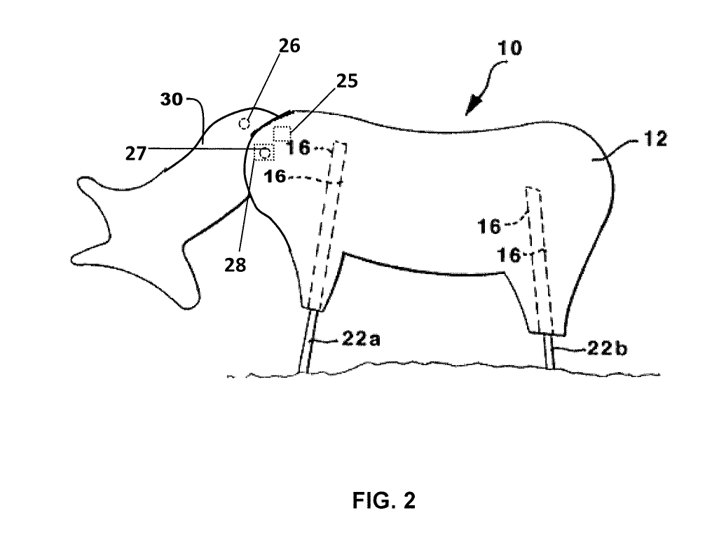

FIGS. 1-2 show several views of an embodiment of the present decoy system. FIG. 1 illustrates a side view of a deer decoy 10 with its head in an upright position. FIG. 2 illustrates a side view of deer decoy 10 with the head positioned downward, such as to imitate a pose of a deer that may be grazing. The decoy 10 includes a neck and head portion 30 and body 12 made from a two dimensional fabric material.

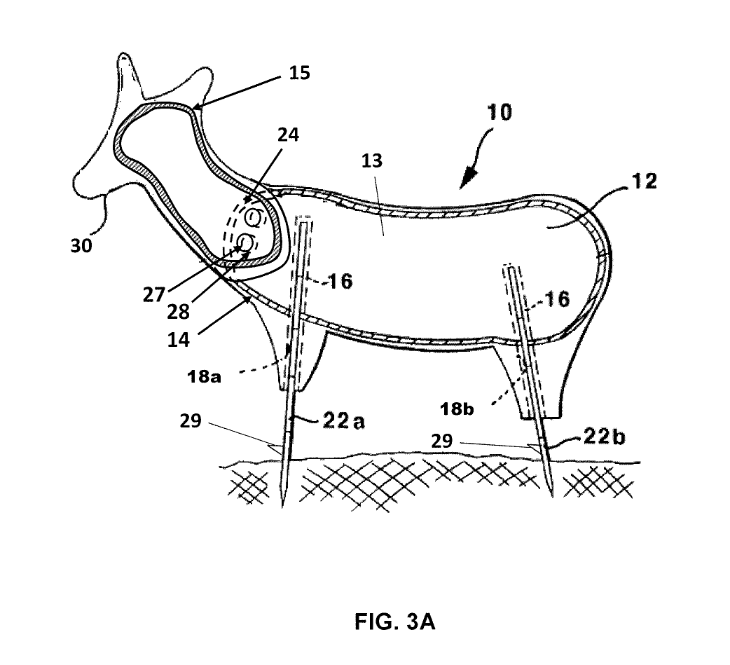

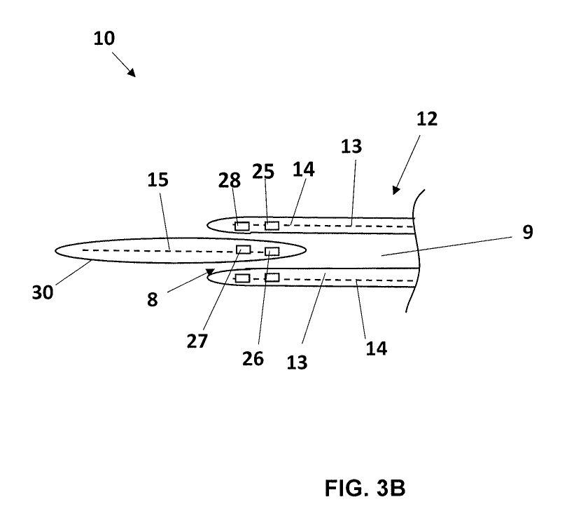

FIG. 3A illustrates a cross-section side view of the animal decoy 10 shown in FIG. 1. Body 12 is comprised of torso section 13 that includes a fabric pocket and an internal member that provides a semi-rigid structure to the fabric pocket. The internal member of torso section 13 may be configured to stretch the fabric into the shape of at least a part of a decoy.

At least one coil spring band 14 of spring steel or other suitable flexible yet resilient material is positioned inside the torso section 13 of decoy 10 to provide structure and hold the fabric in the shape of a deer torso. Likewise, the decoy 10 includes an attachable neck and head 30 that also includes a coil spring band 15 and is formed in the same manner as the torso section 13. The torso section 13 and neck and head region 30 are composed of a fabric material that has no structure of its own; i.e. without internal or external rigid members for support, it may conform to the forces acting on it, such that it may be crumpled in a pile, folded over itself, or otherwise take a shapeless form. The coil spring bands 14, 15 are inserted into the pocket of fabric forming the torso section 13 and neck and head region 30, respectively, to provide a semi-rigid shape to the decoy body 10. The fabric pockets that comprise torso section 13 and neck and head region 30 of decoy 10 are shaped such that when they are fully outstretched and flat they are in the two-dimensional shape of an animal or portion of an animal. Internal rigid members (i.e., coil spring bands 14 and 15) are positioned to expand to the perimeter of the pocket in which they are inserted, thereby holding the fabric in an outstretched and semi-rigid shape. For example, in one embodiment a coil spring band 14 is inserted into to the torso section 13. When coil spring band 14 is not constrained (e.g., able to expand out to its full perimeter), coil spring band 14 operates to hold the fabric of torso section 13 outstretched in the shape of a deer torso. Likewise, a coil spring band 15 is inserted into the neck and head region 30 to support the fabric in the shape of a deer head. The coil spring bands 14, 15 can be twisted and folded using the “twist/fold” technique that has been used conventionally in other items such as sun shades for car windows and band saw blades. This folding technique, which is further described below, allows the decoy 10 to be greatly reduced in size for ease of transportation and storage.

Referring to FIGS. 1-3, the two dimensional fabric that makes up the decoy 10 can be a fabric such as polyester, cotton, nylon, or any number of woven fabrics. The fabric is printed to resemble the color, texture, fur, and other visual features that would be expected to create a realistic image of an animal. The fabric is made as a hollow structure (e.g., a pocket) in which coil spring band 14 may be positioned to press the fabric into an outstretched form by the expansion of coil spring band 14. In one embodiment illustrated in FIG. 3, the torso section 13 comprising the body 12 is configured to be the general shape of the torso of the animal which decoy 10 is intended to imitate. In this example, body 12 is an oblong circular shape resembling a deer torso and including two ventral protrusions resembling deer legs. The band 14 is inserted into the hollow defined by the fabric of torso section 13 and expands outward to hold the fabric in tension in an oblong torso shape that forms body 12. In an example embodiment, a separate neck and head 30 portion is configured to seperably attach to body 12.

In one embodiment, decoy 10 is configured to have two functionally identical torso sections 13 forming the body 12. Two oblong two-dimensional torso sections 13, each comprising a fabric pocket with an internal coil spring band 14, comprise body 12. Two oblong torso sections 13 are joined concentrically and adjacently by a sewn seam along the perimeter of the sections to create body 12 with a hollow pocket between the torso sections 13 configured to receive the neck and head region 30. In FIG. 3A, body 12 of decoy 10 is shown in cross-section along a median sagittal plane between torso sections 13. Thus only one torso section 13 and internal coil spring band 14 are depicted. A small area 24 near the lower neck region of the deer is formed by a section of body 12 where the decoy torsos 13 are not joined, creating an aperture that provides access to the interior space formed between the two body sections. An aperture acts as a receiving area for an attachable neck and head portion 30.

A neck and head portion 30 may be formed in a similar manner to a torso section 13; a piece of fabric configured to the general shape of the neck and head portion of the animal which it is intended to imitate is expanded by an internal spring coil band 15. The neck and head portion 30 may be inserted into the aperture in the body 12 to create an animal decoy.

FIG. 3B illustrates a cross-section top-view of decoy 10, where two torso sections 13 are joined by sewn seam 9 around their perimeter. Aperture 8 is formed by a portion of the body 12 where seam 9 does not join torso sections 13. Neck and head portion 30 is partially inserted into body 12 through aperture 8.

While using the decoy in the field it may be necessary or beneficial for a user to be able to move the position of the head of a decoy to provide a more realistic imitation or to create the impression of multiple animals. Referring to FIGS. 1-2, the decoy is illustrated in two different poses. The body 12 may interface with the neck and head region 30 in a manner that accommodates different positions. The neck and head 30 location may be repositionable relative to the body 12. Fasteners located in the body 12 and neck and head portion 30 may be used to secure the pieces together as a single entity in a variety of positions while remaining easily removable by a user for repositioning. In an example embodiment illustrated in FIG. 3A and FIG. 3B, magnets 25, 28 may be sewn into a pocket in the torso section 13 and magnets 26, 27 may be sewn into a pocket in the neck and head portion 30 for this purpose, though other fasteners such as Velcro, buttons, zippers, or other suitable options may be used as well. Fasteners may be selectively coupled or decoupled to accommodate fixing the relative locations of the neck and head region 30 and the body 12. For example, in FIG. 1 magnets 24 and 25 in the body 12 are coupled to magnets 26 and 27 in the neck and head region 30, holding the neck and head region in an upright position. In FIG. 2, magnet 25 in the torso section 13 has been decoupled from magnet 26, and neck and head region has rotated about an axis formed by magnets 27 and 28. Magnets 27 and 28 attach the neck and head region 30 with body 12. In this specific embodiment only four fasteners are described, but one skilled in the arts would realize that any number of fasteners may be included as needed to attach the neck and head region to the body and accommodate a number of positions.

In an alternate embodiment, the head and neck region 30 may be integrated with the body 12 as a piece of fabric configured to resemble the shape of an animal to be imitated. In this embodiment the location of the head relative to the body may not be positionable or moveable. One or multiple coil spring bands may be used to hold the fabric in an outstretched position in order to create a two-dimensional silhouette of the animal to be imitated. The fabric may include internal pockets to hold at least one coil spring band to provide structure to the fabric, and there may not be access, such as through an aperture, of the internal cavity or pocket. In some embodiments, different pockets may be sewn into the body to accommodate a plurality of coil spring bands in different bodily areas of the decoy. For example, there may be one coil spring band in the torso section of a decoy and a second coil spring band in the neck and head portion of a decoy. Each coil spring band may be appropriately sized and shaped for use in a particular bodily area and configured to stretch the fabric in a manner that creates a realistic anatomical shape of the animal to be imitated. In an alternative embodiment, a two dimensional material such as cardboard, plastic, fiberboard, or other suitable material that may maintain a rigid or semi-rigid structure may be used in one of the internal pockets of the decoy for a particular bodily part. For example, a piece of rigid or semi-rigid material may be cut into the two dimensional shape of a head and neck portion of an animal to be imitated and inserted into an internal pocket to stretch the fabric into that particular shape. The decoy may be configured so that the body portion containing the rigid or semi-rigid material may be folded flat over the planar shape of the decoy after the coil spring band is collapsed using the “twist/fold” technique for ease of storage or transport.

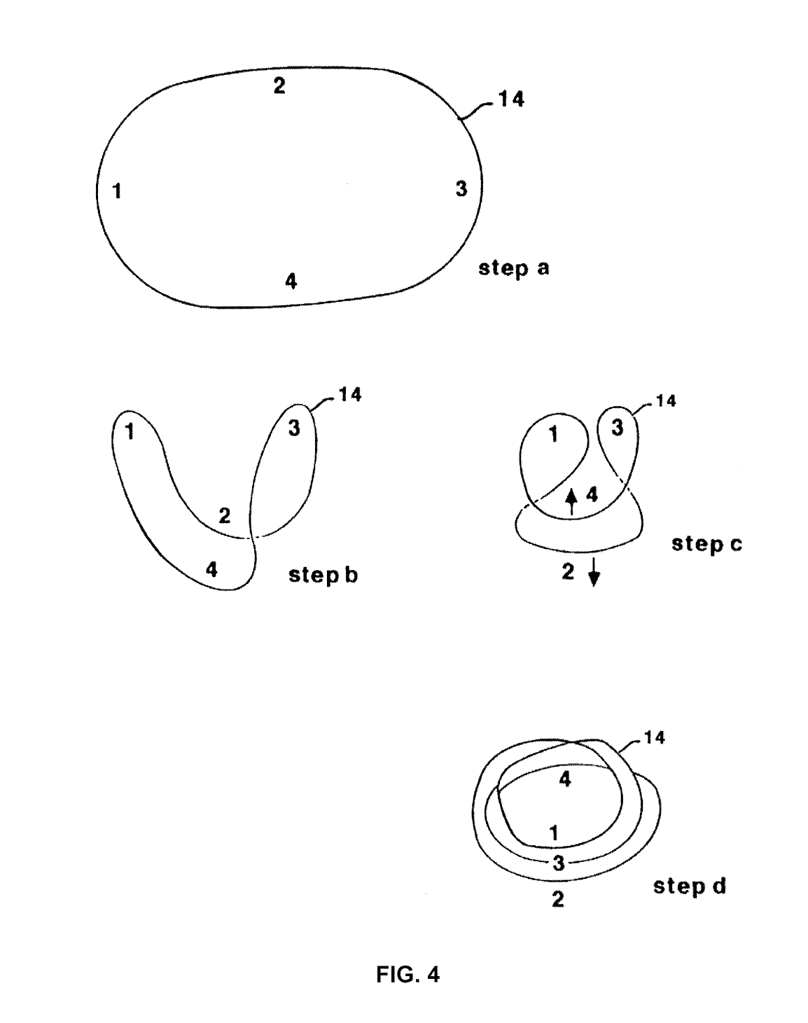

The “twist/fold” technique is shown schematically in FIG. 4. In the depicted example, coil spring band 14 is depicted without the surrounding material of body 12. The manipulations of coil spring band 14 depicted in FIG. 4, therefore, may be understood to involve similar manipulations of the fabric of body 12. In FIG. 4, the fabric of body 12 is not depicted to simplify the depiction of coil spring band 14 as shown in FIG. 4.

Coil spring band 14 is generally formed of spring steel and is shown in step “a” in an expanded condition (e.g., fully occupying body 12 and expanding body 12 into the shape depicted in FIG. 3). For purposes of explanation, coil spring band 14 has segments labeled 1, 2, 3, and 4 as shown in FIG. 4. Note that the depicted segments are only for reference as in some embodiments coil spring band 14 may be formed as a single band of continuous material. To start the twist/fold, segments 1 and 3 are raised toward each other, (a person grasps coil spring band 14 adjacent segments 1 and 3 with his two hands) while segments 2 and 4 drop, as shown in step “b”. A saddle shape is thus formed with segments 1 and 3 extending upwardly, and segments 2 and 4 extending downwardly. In step “c”, segment 1 is twisted toward the user and segment 3 is twisted away from the user. When this is done, the coil spring band 14 collapses into 3 rings overlying one another as shown in step “d”.

Although FIG. 4 depicts a process for collapsing coil spring band 14 (and, thereby body 12 of decoy 10), it should be understand that a similar “twist/fold” process may be utilized to collapse coil spring band 15 (and, thereby, head 30) of decoy 10.

Each of the coil spring bands 14, 15 may be a steel spring, the size of which may be changed depending upon the size of the animal or portion of the animal being depicted. For example, a single decoy may comprise a coil spring band sized for the torso of an animal and a coil spring band sized for the head of a decoy. Likewise, the diameter of the steel spring comprising the band can be modified depending on the type of animal being imitated. As an example, deer decoy 10, which is intended to be used in deer hunting, might have a coil spring band in which the diameter of the coil itself is 12 inches, with the coil spring band extending to approximately 3 feet or more when it is fully extended. A decoy may also include a single or multiple storage straps 32 which can be a loop of elastic material. Once the body 12 of decoy 10 is collapsed using the “twist/fold” technique it is basically a flat planar shape. Storage straps 32 can be slipped over the flattened form, or otherwise connected to secure the flattened form in the collapsed state, and the deer decoy can be stored and/or transported as a substantially planar dish shape. In this collapsed form multiple decoys or parts of decoys may also be stacked together and bundled for minimum storage space and ease in transport.

A decoy may be deployed in the field by staking the decoy into the ground. This allows the decoy to be easily placed in nearly any location or orientation. This method also secures the decoy in an upright position, and helps prevent the decoy from falling over. Leg poles or other support pieces may be integrated or seperably attached to a decoy. In one embodiment, the body 12 may further be sewn with stitching 16 to form channels 18a, 18b. A pair of collapsible leg poles 22a and 22b are inserted in open ended channels 18a and 18b respectively. The channel 18a is positioned adjacent to the front leg as shown in FIG. 3A and channel 18b is positioned adjacent to the rear leg as shown in FIG. 3. The leg poles 22a and 22b extend away from the body of decoy 10, and the distal end thereof are pointed for easy insertion into the ground, as shown in FIG. 3. In a certain embodiment, leg poles may include protrusions 29 extending outward perpendicularly from the longitudinal axis of the pole. These protrusions 29, located near the distal end of the pole, may be used to aid insertion into the ground by providing a surface for applying downward force, such as with the bottom of a shoe, a hammer, or other appropriate method. In a preferred embodiment, leg poles 22a and 22b may be collapsible such that they become shorter in length when disassembled for easier transport or storage. Two segments of pole may be joined longitudinally together by an end of one segment of pole extending tightly into an enlarged socket permanently fastened to an end of a second segment of pole. Any number of constituent pole segments may be joined in this fashion to create a single leg pole such as 22a and 22b for supporting the decoy. Rope, elastic, or a similar fastener may be used to flexibly attach the ends of the pole segments for storage or transport when not erected as a leg pole.

When poles 22a and 22b are fully inserted into channels 18a and 18b, respectively, they may be secured to the body 12 of the decoy. Fasteners positioned on a segment of the leg poles 22a and 22b may attach to the body 12 of the decoy. In a preferred embodiment, a loop of elastic fabric sewn to the distal end of each channel 18a and 18b and may attach to a clip, hook, or similar fastener positioned on a segment of the leg poles 22a and 22b such that the body 12 is securely attached and the legs of the decoy are fully extended.

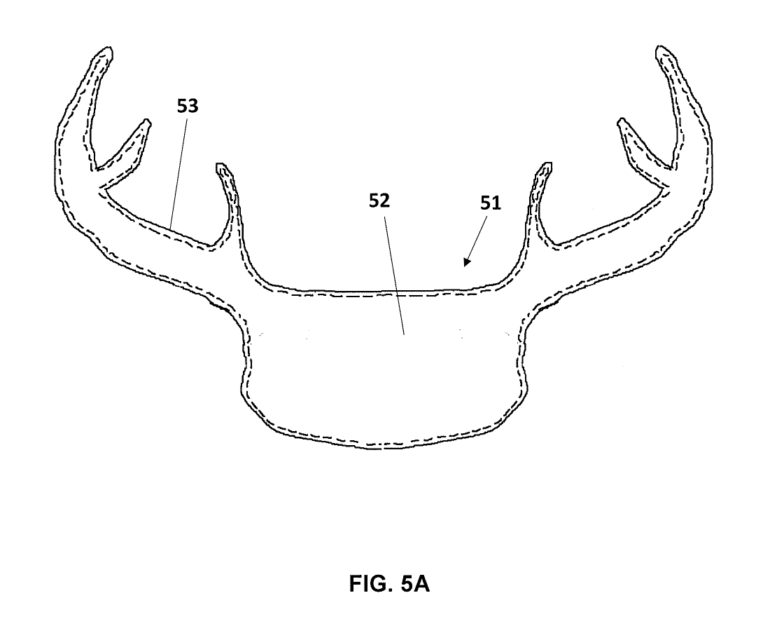

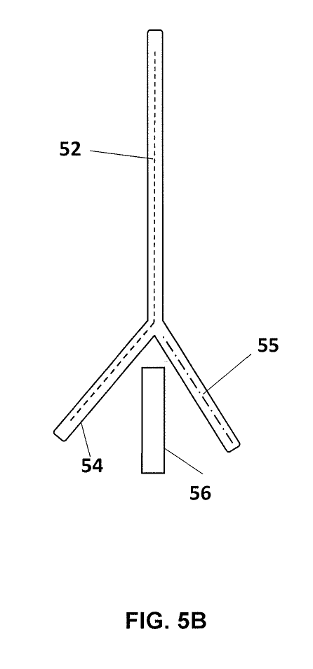

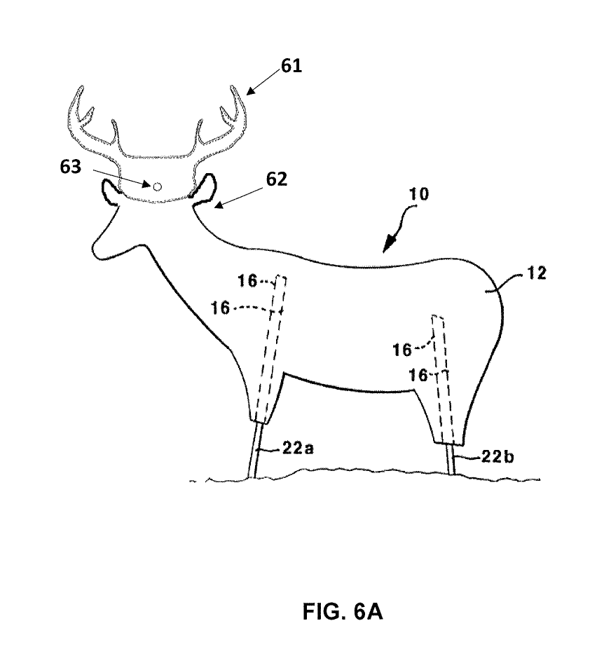

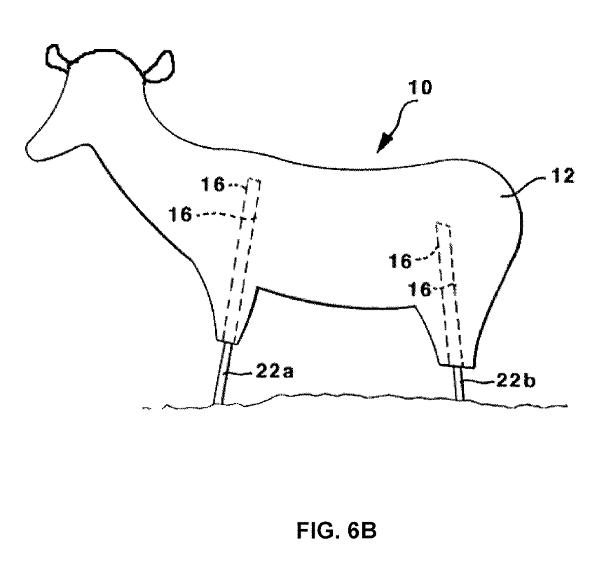

In some instances in the field, it may be necessary or beneficial to further change the appearance of a decoy. For example, depending upon the time of year, particular decoys having particular appearances may be preferable. In the present disclosure, a single decoy may be made to appear as a male or as a female through the addition or removal of optional pieces of equipment. In some embodiments there may be additional pieces that can be attached to a decoy in order to change or alter the appearance of the decoy. FIG. 5a depicts an example embodiment in the form of deer antlers 51. Two pieces of fabric configured to the shape of a deer antler silhouette are joined such that there is a hollow space between them. A structural member 52 made of a rigid or semi-rigid material, such as plastic, cardboard, fiberboard, or other appropriate material may be configured to the shape of the antler silhouette and received in the hollow space between the two pieces of fabric such that it provides structure to the fabric and maintains the antler silhouette. The two pieces of fabric may in general be sewn together along the perimeter of the silhouette creating a seam for nearly the entire length. A portion 54 of the perimeter may not be joined, allowing the two pieces of fabric to be manually separated revealing at least a portion of the interior hollow space. FIG. 5B depicts the side view of the antlers piece where the two pieces of fabric have been separated along portion 54. A second structural member 55 made of a rigid or semi-rigid material may be configured to the shape of the revealed interior hollow space and attached thereto. Structural members 52, 55 may provide support for the fabric to be opened like a clamshell along the portion 54 of the perimeter where it is not joined, as depicted in FIG. 5B. An antler piece may then be placed on a head portion of a decoy 56, wherein the head portion is placed in the interior hollow space of the clamshell. FIG. 6A further illustrates how this additional piece may be implemented with a decoy. In this example embodiment, an antlers piece 61 may be attached to a head 62 of a decoy, where the planar face of a head is placed between two interior faces of the clamshell formed by the structural members of an antlers piece. A fastener may be used to secure an antlers piece 61 to a head of a decoy. In a preferred embodiment, this fastener may be magnets 63 which are located in an each clamshell portion an antlers piece between each structural member and the outer fabric covering; i.e.: the magnets would not be exposed to the exterior. Magnetic attraction causing compressive force on a head 62 of a decoy from an antler piece clamshell would secure the antler piece in place. While in the field a user of the decoy would be able to alter the appearance of a decoy by adding or removing an antler piece from a head of a decoy. The fabric may be printed with patterns or images that convey the likeness of deer antlers, and configured such that the portion of the antlers piece 61 that overlaps with a head of a decoy 62 would have identically printed fabric such that the antlers piece would integrate with the head of the decoy for a realistic continuous image when properly aligned. As illustrated in FIG. 6b, the antler piece may be removed to change the appearance of a decoy.

Although the example embodiments described herein describe a deer decoy, the animal decoy could be almost any animal, including predators. For example the animal decoy could be an elk, a moose, a wolf, a mountain lion, etc. Similarly, the example of an antlers piece as an extra piece that could be optionally attached to the decoy should not be seen as limiting. Convertible pieces could also include other body parts or configurations of body parts, for example a tail or ears, or non-body parts like hunting blaze, retroreflectors, or other attachments that may be useful. One skilled in the art will realize that a virtually unlimited number of variations to the above descriptions are possible, and that the examples and the accompanying figures are merely to illustrate one or more examples of implementations.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

It will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments or implementations disclosed, but that such claimed subject matter may also include all embodiments or implementations falling within the scope of the appended claims, and equivalents thereof.

In the detailed description above, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Reference throughout this specification to “one embodiment,” “an embodiment,” “one implementation,” or “an implementation” may mean that a particular feature, structure, or characteristic described in connection with a particular embodiment or implementation may be included in at least one embodiment or implementation of claimed subject matter. Thus, appearances of the phrase “in one embodiment,” “an embodiment,” “one implementation,” or “an implementation” in various places throughout this specification are not necessarily intended to refer to the same embodiment or implementation, or to any one particular embodiment or implementation described. Furthermore, it is to be understood that particular features, structures, or characteristics described may be combined in various ways in one or more embodiments or implementations. In general, of course, these and other issues may vary with the particular context of usage. Therefore, the particular context of the description or the usage of these terms may provide helpful guidance regarding inferences to be drawn for that context.

What is claimed is:

1. An animal decoy comprising:
a body, the body including:
a pocket including fabric material,
a metal band disposed within the pocket, wherein the metal band is configured to bias the body into an expanded shape, the metal band being collapsible by twisting and folding the metal band on itself,
a first fastener attached to the fabric material, and
a second fastener attached to the fabric material; and
a head, the head including:
a second pocket including a second fabric material,
a second metal band disposed within the second pocket, wherein the second metal band is configured to bias the head into an expanded shape, the second metal band being collapsible by twisting and folding the second metal band on itself, and
a third fastener attached to the second fabric material, wherein the third fastener is configured to removably couple to the first fastener to position the head in a first position with respect to the body and the third fastener is configured to removably couple to the second fastener to position the head in a second position with respect to the body.

2. The animal decoy of claim 1, wherein the fasteners are magnets.

3. The animal decoy of claim 1, further comprising leg sleeves including a fabric material attached to the body.

4. The animal decoy of claim 1, further comprising poles positioned in the leg sleeves.

5. The animal decoy of claim 1, wherein the mounting poles include elements to assist in pushing the poles into the ground.

6. The animal decoy of claim 1, further comprising a removable set of antlers.

7. The animal decoy of claim 6, wherein the removable set of antlers resemble the shape of FIG. 5b.

8. The animal decoy of claim 1, wherein the first position corresponds to an eating position, and the second position corresponds to an upright position.

9. An animal decoy comprising:
a first portion including:
a pocket including fabric material, and
a band disposed within the pocket, wherein the band is configured to bias the first portion into an expanded shape, the band being collapsible by twisting and folding the band on itself; and
a second portion including:
a second pocket including a second fabric material, and
a second band disposed within the second pocket, wherein the second band is configured to bias the second portion into an expanded shape, and wherein the second portion is configured to removably couple to the first portion in at least a first position with respect to the first portion and a second position with respect to the first portion.

10. The animal decoy of claim 9, wherein the first portion is a body and the second portion is a head and neck region.

11. The animal decoy of claim 9, wherein the second portion includes fasteners to couple the second portion to the first portion in the first position and second position.

12. The animal decoy of claim 11, wherein the fasteners are magnets.

13. The animal decoy of claim 9, further comprising leg sleeves including a fabric material attached to the first portion.

14. The animal decoy of claim 13, further comprising poles positioned in the leg sleeves.

15. The animal decoy of claim 14, wherein the poles include elements to assist in pushing the poles into the ground.

16. The animal decoy of claim 9, further comprising a removable set of antlers.

17. The animal decoy of claim 16, wherein the removable set of antlers have the shape of FIG. 5B.

18. The animal decoy of claim 9, wherein the first position corresponds to an eating position, and the second position corresponds to an upright position.

19. A device, comprising:
a first pocket including fabric material;
a band disposed within the first pocket to bias the first pocket into an expanded shape;
a second pocket including a second fabric material; and
a second band disposed within the second pocket to bias the second pocket into an expanded shape, wherein the second pocket is configured to removably couple to the first pocket in at least a first position with respect to the first pocket and a second position with respect to the second pocket.

20. The device of claim 19, wherein the device is an animal decoy.
